(19) United States
(12) Patent Application Publication
(10) Pub. No.: US 2007/0091104 A1
(43) Pub. Date: Apr. 26, 2007

(54) Computer system and method

(76) Inventors: Gajendra Prasad Singh, Sunnyvale, CA (US); Tzungren Allan Tzeng, San Jose, CA (US); Rabin A. Sugumar, Sunnyvale, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/483,958

(22) Filed: Jul. 10, 2006

Related U.S. Application Data
(60) Provisional application No. 60/697,508, filed on Jul. 8, 2005.

(51) Int. Cl. G09G 5/39

(52) U.S. Cl. 345/531

(57) ABSTRACT

This document discusses, among other things, a system and method for connecting a plurality of memory controllers to one or more memory modules. Each memory module includes an advanced memory buffer (AMB) connected to a plurality of memory devices. A switch is connected between the plurality of memory controllers and the one or more memory modules. A memory read request is routed from one of the plurality of memory controllers through the switch to a preselected memory module.

### RELATED APPLICATION

This application claims priority to U.S. Provisional Application Ser. No. 60/697,508, filed Jul. 8, 2005, which is incorporated herein by reference.

### TECHNICAL FIELD

This patent document pertains generally to the field of computer systems and more particularly, but not by way of limitation, to a system and method for connecting a plurality of memory controllers to one or more memory devices.

### BACKGROUND

A cluster of compute nodes working on a shared data space is highly prevalent today. Such clusters are used, e.g., for genomics research, data mining, and web serving. Today, the nodes in each typical cluster each have their own private memory. Such an approach results in several inefficiencies: (1) there is much data duplication among the nodes resulting in high memory cost and power; (2) memory cannot be dynamically reallocated among nodes resulting in over provisioning of memory at each node; and (3) inter-node communication is over a network fabric resulting in high communication overheads.

What is needed is a system and method for connecting memory controllers to memory devices which addresses these issues, and other issues that will become apparent in reading this patent document.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a computer system according to one aspect of the present invention.

FIG. 2 illustrates a computer system according to another aspect of the present invention.

FIG. 3 is a flowchart diagram describing one embodiment of the function that takes command, address and data from the memory controllers directs them to target FBDIMM channels leading to memory devices.

FIGS. 4A and 4B illustrate one embodiment of the function that breaks up packets received from memory controllers into subpackets, where each subpacket has distinct command, address or data content potentially targeting different memory devices.

FIG. 5 is a block diagram illustrating one embodiment of the routing function that takes subpackets and directs them to the FBDIMM channel connecting to the targeted memory devices.

FIG. 6 is a block diagram illustrating one embodiment of the data buffering and delaying function that returns load data to memory controllers exactly on the expected cycle.

FIG. 7 is a block diagram illustrating another embodiment of the data buffering and delaying function that returns load data to memory controllers exactly on the expected cycle.

FIG. 8 is a schematic diagram of one embodiment of the store buffering, completion and camming function.

FIG. 9 is a flowchart diagram illustrating one embodiment of the function that returns errors causing the controller to issue a retry as a method to handle collisions on load accesses.

FIGS. 10A and 10B illustrate an alternate approach for informing memory controllers about collision delays.

FIG. 11 illustrates a refresh handling function.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

A memory channel (or bus) consists of a collection of signals that connect logic implementing a controller on an integrated circuit to memory devices. The set of signals constituting a bus include control signals that are used by the controller to inform the memory device on whether a read or write or some other transaction is desired, address signals that are used by the controller to inform the memory device about the location in the device that is to be read, or written or otherwise activated, and data signals that are used by the controller to transfer data to be written into the memory device and to receive data read from the memory device.

A memory channel has an associated access protocol to communicate commands, addresses and data in accordance to which both the controller and the memory device are designed. Over the years a number of memory channels and their associated access protocols have been defined and placed in use in the industry. Examples include EDO DRAM, SDRAM and DDR SDRAM.

Fully Buffered Dual Inline Memory Modules (FBDIMM) are a relatively recent memory channel and protocol development. One difference between the FBDIMM protocol and earlier memory protocols is that there is a two level connection between the controller and the memory device. The controller sends and receives commands, addresses and data to and from an advanced memory buffer (AMB) using the FBDIMM channel. The AMB then communicates with the memory devices using a different channel such as DDR SDRAM.

The FBDIMM protocol allows multiple AMBs to be chained together where the memory controller connects to one AMB, which connects to another AMB and so on, where each AMB connects to an associated set of memory devices. Memory protocols prior to the FBDIMM protocol, including the examples mentioned in the previous paragraph, have a single level of access where the controller connects directly to memory devices.

One can take advantage of the multi-level access scheme defined in the FBDIMM protocol to insert another logic module between the controller and the AMB(s). The added logic module routes FBDIMM channels originating at several controllers to FBDIMM channels leading to many AMB chains. Such a computer system organization of controllers and memory allows several controllers to share a large pool of memory. In one embodiment, the added logic module is implemented as an integrated circuit.

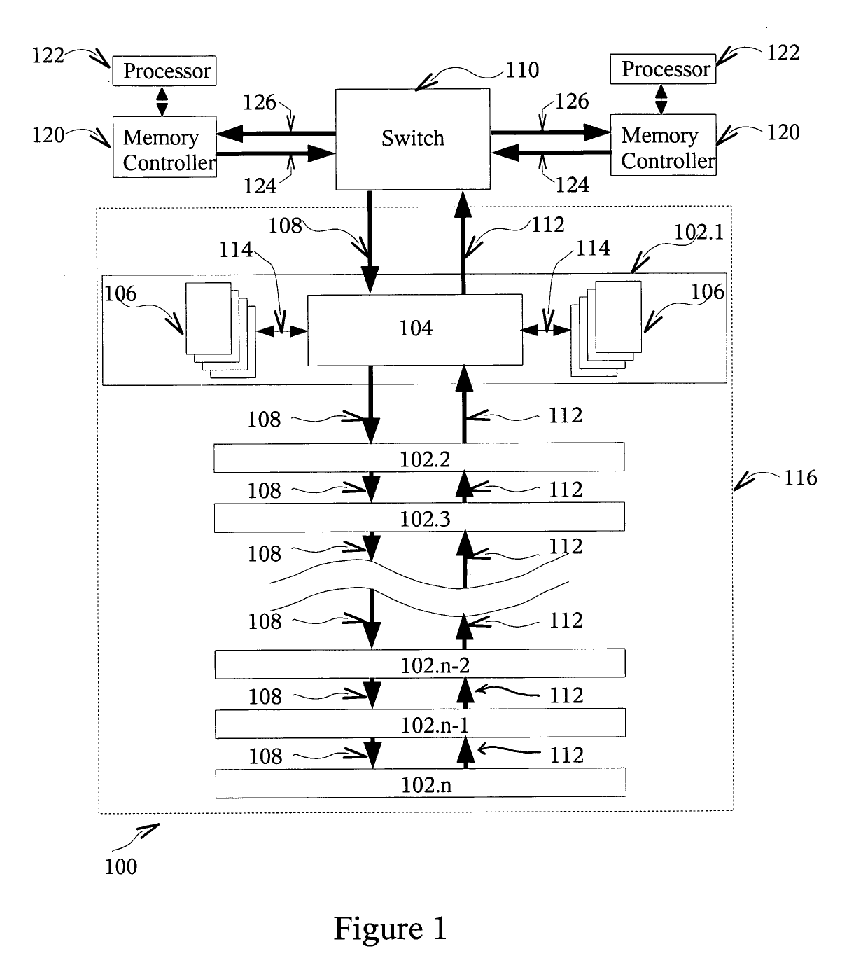

An embodiment of a computer system having a plurality of memory controllers connected to one or more memory modules is shown in FIG. 1. In computer system 100 of FIG. 1, the plurality of memory controllers 120 are connected through a switch 110 to memory modules 102. In the embodiment shown, a serial link 124 receives packets from memory controller 120 while a serial link 126 returns packets to memory controller 120.

In one embodiment, each memory controller 120 is connected to one or more processors 122 and receives memory access instructions from processors 122.

Each memory module 102 includes an advanced memory buffer (AMB) 104 and two or more memory devices 106. The memory devices 106 are connected to AMB 104 through channel 114.

In the embodiment shown in FIG. 1, multiple AMBs 104 are chained together based on the FBDIMM protocol. A set of point to point serial links (108) extend from switch 110 through the AMB 104 located on the first memory module 102 to an AMB 104 on each of the other memory modules 102. These serial links, together with the memory modules 102 they connect, form the southbound datapath.

At the same time, a set of point to point serial links (112) extend from the AMB 104 on the last memory module 102.n, through the other AMBs 104 to switch 110. These serial links, together with the memory modules 102 they connect, form the northbound datapath. The combination of the southbound and northbound paths form a memory channel 116.

In one embodiment, memory modules 102 are implemented as DIMMs Dual Inline Memory Modules).

In one embodiment, each set of memory devices 106 includes one or more banks. In order to perform a read operation from a memory device 106 the targeted bank is first made active with an ACTIVE command, and then the target datum within the bank is read with a READ command. In order to perform a write operation to memory devices the targeted bank is first made active with an ACTIVE command, and then the target datum within the bank is written with a WRITE command. These commands are sent to the memory devices (106) from AMB 104, but the controlling device 120 is the originator of the command, which is then relayed to the memory devices by the AMB 104.

Command, address and data information flowing from the controlling device 120 to the memory modules 102 and status and data information flowing from the memory modules 102 to the controlling device are formed into packets and transferred over the serial links. Each packet going from the controlling device to the memory modules 102 may contain command, address and data information targeted at different destination memory modules 102. As an example a packet can contain a READ command targeted at the first memory module 102, and ACTIVE commands targeted at the second board and the last board for a total of three commands in one packet.

On issue of a READ command by the controlling device, the targeted memory module 102 performs the read and returns the data in one or more packets. The delay between the issue of the READ command by the controlling device and data return from the targeted memory module 102 is not necessarily fixed. In one embodiment, the delay is computed at the time the controlling device is powered up, and may occasionally be recomputed if needed.

Stores are performed in two steps. First, data is transferred from the controlling device to a buffer on AMB 104. Second, a WRITE command is issued to complete the write—that is, move data from the buffer to the target address in the memory devices. Multiple data blocks may be buffered up on each AMB 104. Completion is done in the same order in which the data entries were buffered.

Controlling device 120 also issues periodic REFRESH commands to the memory devices 106, since the type of memory device typically used with the FBDIMM protocol requires a periodic refresh operation to hold data.

A cyclic redundancy code (CRC) is associated with each packet traveling on the serial links. AMB 104 or the controlling device 120 that is the destination of a packet performs a CRC check on the packet prior to using its contents.

When a CRC error is detected at the controlling device on data returned for a read, the controlling device may try to perform the read again, and could repeat such retries a few times. If the error is persistent the controlling device may perform a fast reset of the channel in which the reset sequence of the channel is made to minimize the disruption of service to the system. If the error still remains, the controlling device may perform a regular reset of the system. If all fail, the controlling device will have to either dynamically reconfigure the channel out of the system, or if it does not have such dynamic reconfiguration capability, bring down the system for maintenance.

When a CRC error on a southbound command is detected at AMB 104 on a memory module 102, the integrated circuit chip will notify the controlling device 120 through a northbound packet. The controlling device, after being notified by the northbound packet may issue a special command to reset the states of the integrated circuit chips on the channel. Following this controlling device 120 may reissue all READ and WRITE commands since the previous verified command completion and continue normal operation. If the CRC error persists, a fast reset can be issued.

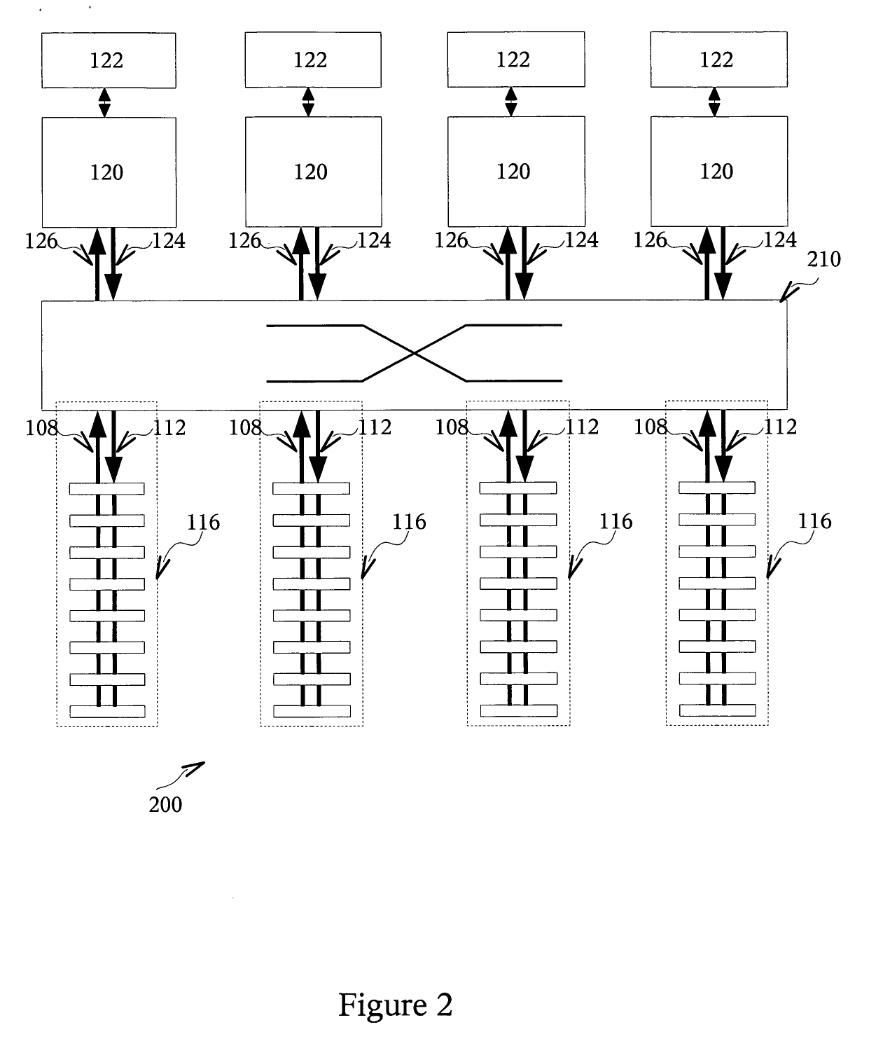

The approach described in connection with FIG. 1 can be extended to two or more FBDIMM channels 116. FIG. 2 shows a computer system 200 having four memory controllers 120 connected through a switch 210 to four FBDIMM memory channels 116. In the embodiment shown, a serial link 124 receives packets from memory controller 120 while a serial link 126 returns packets to memory controller 120.

Command, address and data information originating at any of the controllers 120 may be redirected to any of the FBDIMM channels 116 through switch 210. Data and status information originating at any of the FBDIMM channels 116 may be redirected to any of the controllers 120.

In one embodiment, switch 210 is a electronic device such as an integrated chip. It routes packets from any of the memory controllers 120 to any of the FBDIMM channels 116 and routes packets from any of the FBDIMM channels 116 to any of the memory controllers 120, while ensuring that response packets arrive at the memory controllers 120 at the expected time.

The approach described in the systems of FIGS. 1 and 2 provides several advantages.

One advantage is it allows the compute nodes associated with each controller to share data in memory among each other. In prior art computer system organizations each compute node has visibility to only the memory devices attached to its own controller. So in prior art systems when compute nodes perform processing functions on a common pool of data each node duplicates the data on its private memory devices. Examples of such prior art computer system organizations include compute nodes stacked in vertical or horizontal racks processing genome data for biometric functions, or web data for internet searches. On the other hand when the system organization enabled by this invention is employed such data duplication is avoided leading to substantial reduction in the number of memory devices needed in the system, contributing to substantial reductions in cost.

A second advantage of such an organization is it allows the compute nodes associated with each controller to use differing amounts of memory from the shared memory pool depending on their need. Thus when an application running on one of the compute nodes requires a large amount of memory at some point in time, that compute node can use a large fraction of the shared memory pool, while other compute nodes use a proportionally smaller fraction. When the application no longer needs a large amount of memory the compute node can release the memory, so it becomes available for other nodes. In prior art computer systems, since there is no capability to share memory among nodes each node would have to be provided with a large memory in order for the nodes to be capable of running applications with high memory demand. Alternately in prior art systems a few nodes may be provided with large memory and the application restricted to run on one of the nodes but such restrictions limit flexibility of scheduling applications on nodes, and negatively impact node utilization in some cases.

A third advantage of such an organization is it provides the capability for nodes to communicate among each other through memory. Communication through memory typically has much lower latency than communicating through a network (such as the TCP/IP protocol running over an Ethernet link).

In one embodiment, switch 210 separates packets into two or more subpackets and sends the individual subpackets to different FBDIMM channels 116. In addition, switch 210 combines subpackets from different source packets into packets when appropriate and sends the newly formed packets to different FBDIMM channels 116. In addition, in one embodiment, switch 210 implements reliability and availability algorithms as described below.

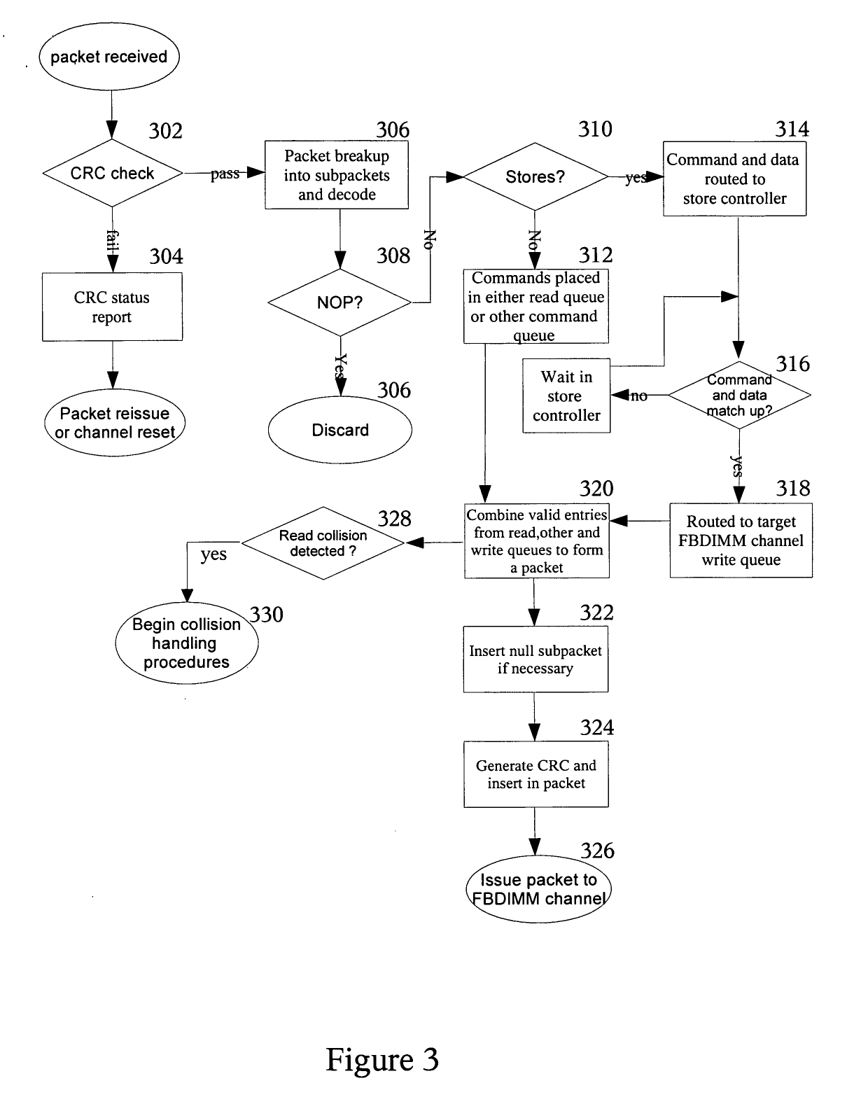

FIG. 3 shows a flowchart detailing one approach for handling command and data packets received in switch 210 from controllers 120.

On receiving a packet from a controller 120 switch 210 first performs a CRC check at 302. If the CRC check fails an error message is sent back to the controller at 304 and the packet is discarded.

If the CRC check is good, switch 210 proceeds to break the packet up into subpackets at 306. Each subpacket is a command or store data or idle. If a check at 308 shows the subpacket is an idle subpacket, that subpacket is discarded. If not, control moves to 310, where a check is made to determine if the subpacket is a store command. Command sections other than store commands are routed to the targeted controller 120 at 312 and are placed in one of two queues: a Read Queue for read commands or a Command Queue for other commands. Store commands and store data are routed to the store controller at 314. Control then moves to 316. Control remains at 316 until the store command and store data are matched up and the store is ready to complete.

When a store command and store data are matched up and the store is ready to complete control moves to 318 and the data-command pair is routed to the targeted FBDIMM channel 116 and placed in a third queue, the Write Queue. As slots become available on an FBDIMM channel 116, commands and data waiting in any of the three queues are combined at 320 to form a packet.

When, however, no command or data is available to fill all available sections, NULL sections are inserted in the packet at 322. A CRC is computed for the packet at 324 and inserted into the appropriate location. The complete packet is then sent out at 326 onto the FBDIMM channel.

When a read collision is detected at 328 resulting in a situation where the FBDIMM data return time specification cannot be met corrective action is taken at 330 as detailed below.

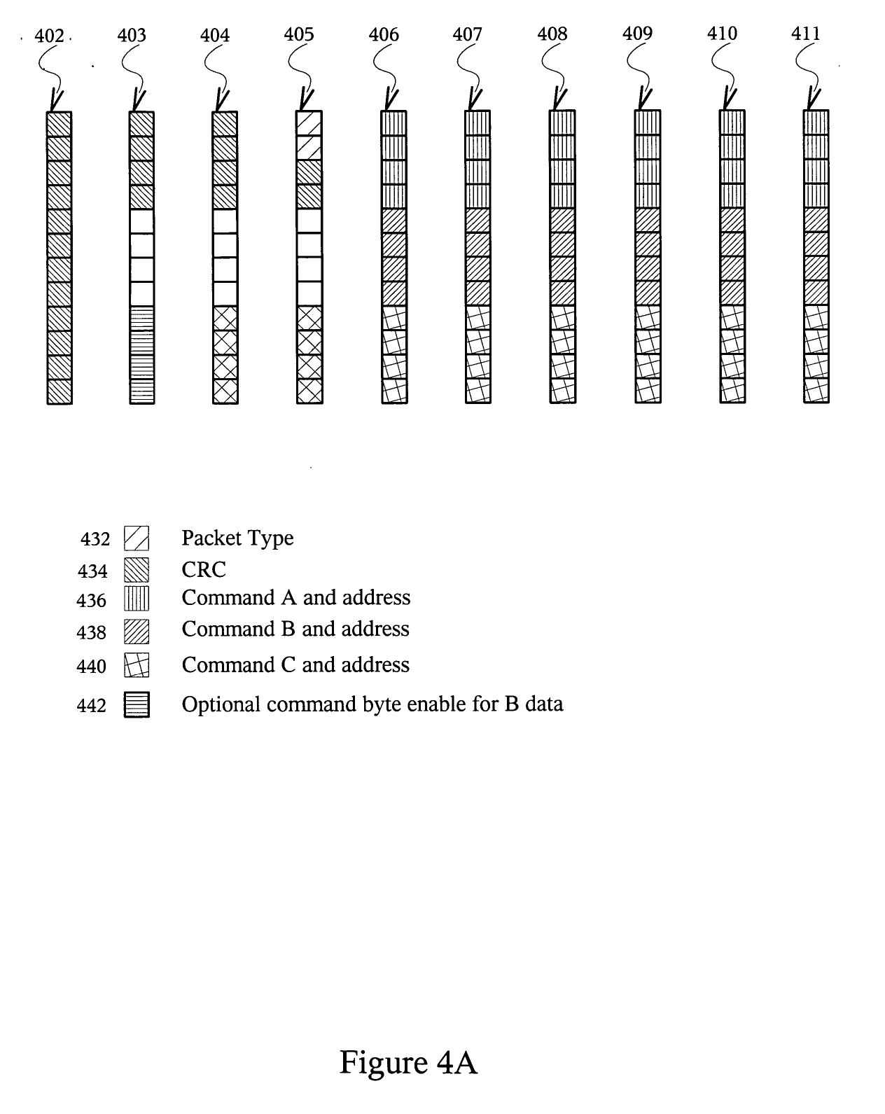

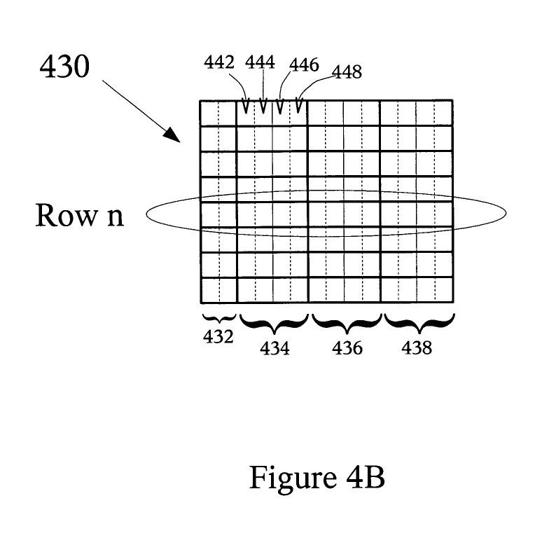

FIG. 4A shows an example of an FBDIMM packet issued by a memory controller 120. The packet is viewed as a set of bit streams (402, 403, 404, 405, 406, 407, 408, 409, 410, 411) coming in on each of the links from the memory controller 120. Bit fields from the different bit streams are combined together to form entities such as commands, address, data or CRC. Bits that combine together to form one entity are shown hashed with the same pattern in the figure, and the different hash patterns are numbered and described in the legend.

As one example from the figure the two bits in Bit Stream 405 with hash pattern 432 provide the packet type for the packet. As another example from the figure, the many bits with hash pattern 434 in Bit Streams 402, 403, 404 and 405 combine together to form the CRC. Similarly, bits with hash pattern 436 combine to form a packet section which includes a command (Command A) and its associated address, bits with hash pattern 438 combine to form a second packet section which also includes a command (Command B) and its associated address, and bits with hash pattern 440 combine to form a third packet section which also includes a command (Command C) and its associated address.

There are also bits with hash pattern 442 that indicate if bits that comprise Command C and address should instead be interpreted as data for command B. It will be clear to one knowledgeable in the art that the figure illustrates one sample packet format, and that many other packet formats are possible with more or fewer commands, addresses and data, and with more types of enable bits that cause some bits of the bit streams to be interpreted in one manner if the enable bits are set and in a different manner if the enable bits are not set.

FIG. 4B shows a table structure which can be used to break a packet into packet sections. Packet type is used to determine which bit fields are to be combined to form packet sections. In the embodiment shown, the packet type is used to index into a table (430) which has several fields indicating the start and end of contiguous bit fields and the order in which they are to be combined to obtain packet sections.

Table 430 shows a maximum of two contiguous bit fields per packet section and a maximum of three packet sections per packet. These constraints are, however, for illustrative purposes only and both constraints may be different depending on the protocol definition. In the example shown in FIG. 4B, the first column (432) of each row provides the bit fields that form the CRC, the second column (434) provides the bit fields that form the first packet section, the third column (436) provides the bit fields that form the second packet section, and the fourth column (438) provides the bit fields that form the third packet section.

In one such embodiment, column 434 can be defined such that part 442 provides the starting bit position of the first field of the first packet section and part 444 provides the end bit position of the first field of the first packet section. Part 446 provides the starting bit position of the second field of the first packet section and part 448 provides the end bit position of the second field of the first packet section. Other configurations are possible as well.

In one embodiment, the bit streams coming on links from memory controllers (e.g., 402 to 411 in FIG. 4A) are broken up and combined into packet sections as defined by table 430 for the packet type of the bit stream by a finite state machine with the aid of shifters, counters and comparators.

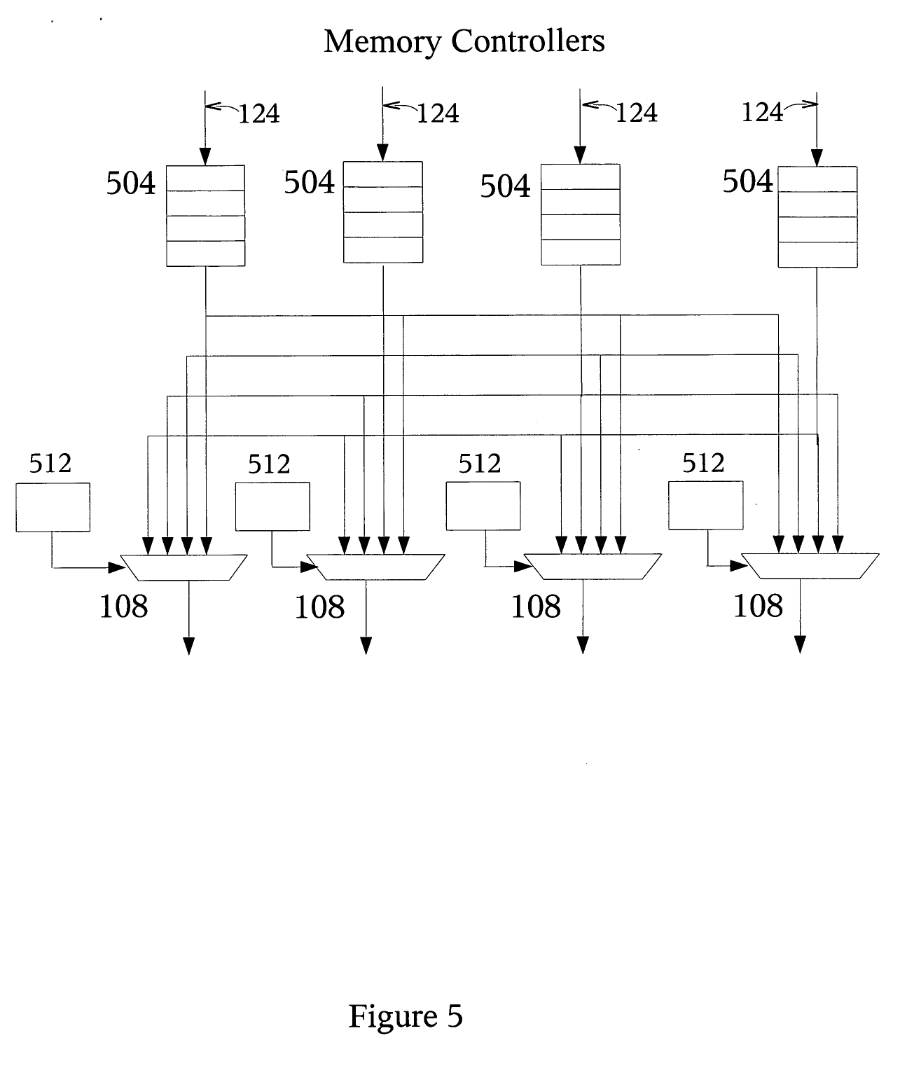

FIG. 5 shows one embodiment of the routing function which takes packet sections originating at any of the controllers 120 and redirects them to the target FBDIMM channel 116. In the embodiment shown, the routing is accomplished through a combination of multiplexers (muxes) 108. In one such embodiment, buffers (504) at each of the ports hold packets in case of a collision.

The target FBDIMM channel is selected by channel selector logic (512). The logic may be implemented through a variety of mechanisms. In one approach, we assign a unique id to each memory module 102 connected to switch 110 or 210, and use the target ids of the command, or even data in the packet itself to determine the channel to which to send the packet.

In another approach, we assign a unique id to each memory module 102 connected to switch 110 or 210 and use a combination of the target ids of the command (or data in the packets) and the higher order bits of the target address to determine the channel 116 to which to send the packet. In yet another approach, we assign a unique id to each memory module 102 connected to the switch and use a combination of the target ids of the command or data in the packets, the higher order address bits of the target address and the node id to determine which channel to send the packet.

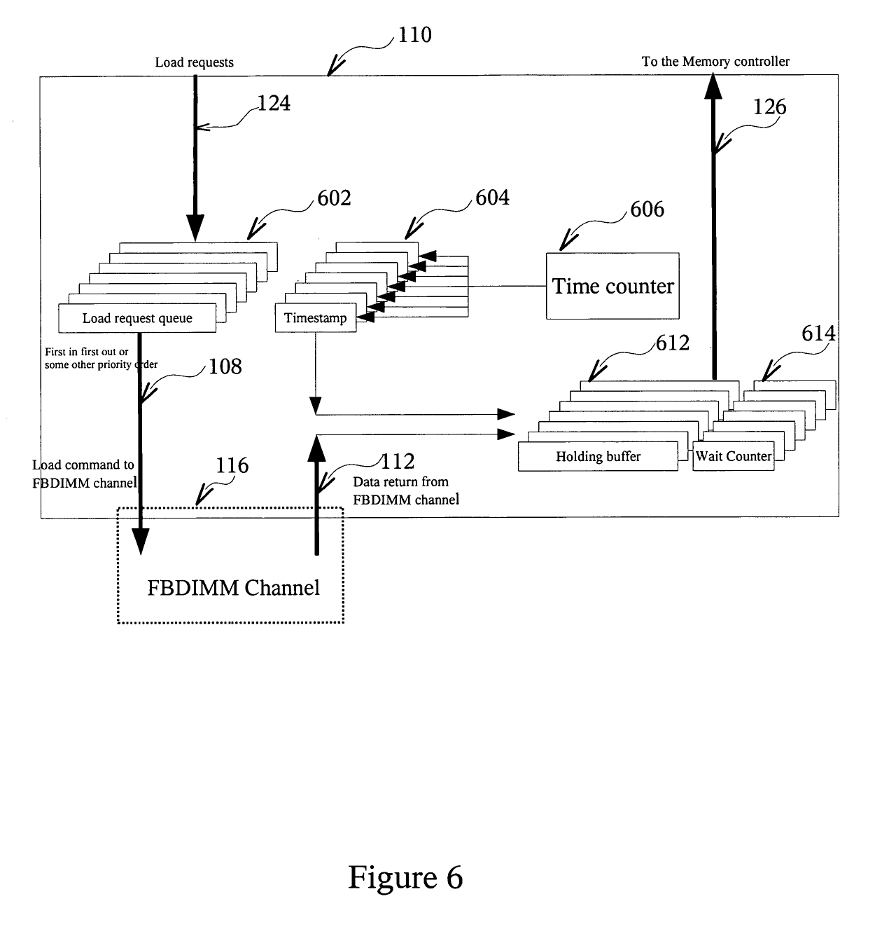

FIG. 6 shows one embodiment of the data return delay function used to return load data to the requesting node at the proper time. The delay required for every load is entered into the switch 610 by some controlling entity (for instance, operating system software or firmware or even by an operator programming input pins of the switch). The load requests going to an FBDIMM channel 116 are entered in a load queue 602 for the channel 116. For each entry in load queue 602 the time of arrival of the load is noted down as a time stamp 604 associated with the entry. In one embodiment, the time of arrival is taken from a time counter 606 that is incremented every clock.

Requests are serviced from queue 602 in a predefined priority order (e.g., first in first out) and are sent to the FBDIMM channels 116. Data returning from the FBDIMM channels 116 is associated with the originating queue entry, and from the time stamp associated with the queue entry the number of clock cycles to delay prior to returning data to the memory controller is determined through simple arithmetic computation implemented on switch 610. The data is then moved to a holding buffer 612 with multiple entries for holding returning data packets.

In one embodiment, a wait counter 614 is associated with each holding entry which is initialized to the wait time determined for the returning packet. The wait counter is decremented every clock cycle and when it reaches zero the packet is returned to the requesting memory controller.

Time counter (606) can overflow when the number of cycles since the time when the counter was zero crosses the highest number the counter can hold. On overflow the time counter goes back to zero. An overflow bit is associated with the counter in order to prevent erroneous wait time computations that may result owing to the sudden non-monotonicity.

The state of the overflow bit is included with each time stamp 604 associated with load queue 602. This overflow bit is factored in during wait time computation and erroneous computations are avoided. Once all entries in the load queue have the overflow bit set, the overflow bit of the time counter can be cleared along with the overflow bits of time stamp entries.

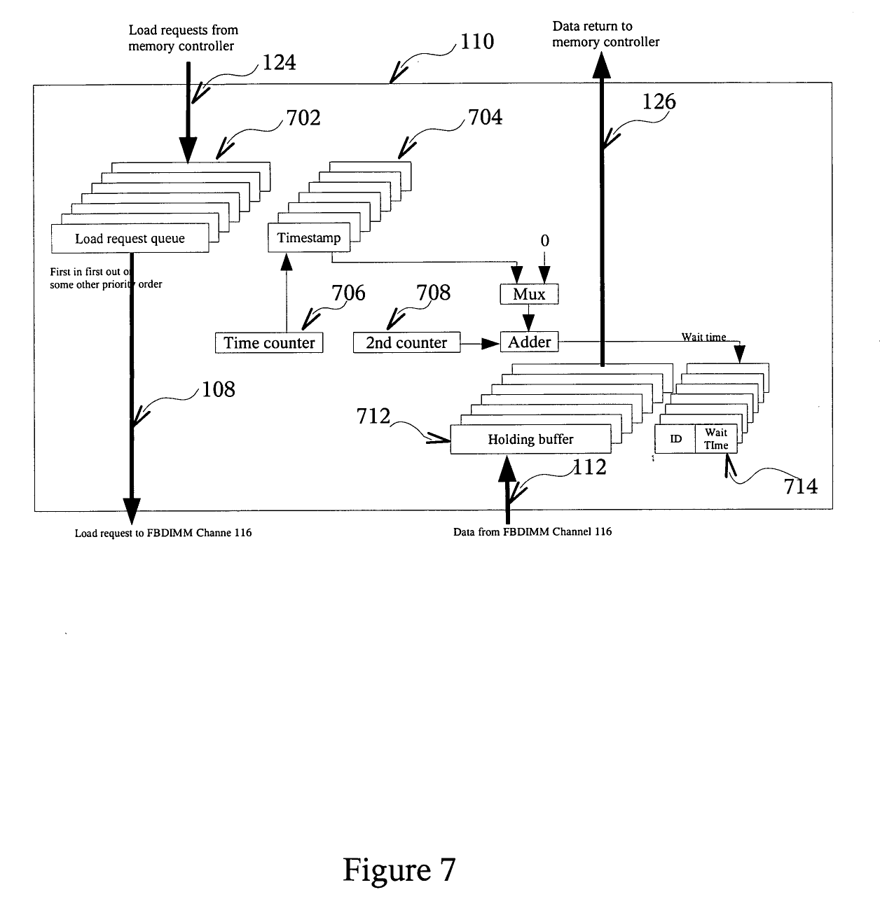

FIG. 7 shows another embodiment of the data return delay function used to return data to the requesting node at the proper time. In the embodiment shown the delay required for every load is entered into the switch 710 by some controlling entity (e.g., through operating system software or firmware or by an operator programming input pins of the switch 710). The load requests going to an FBDIMM channel 116 are entered in a queue 702 along with their time of arrival which is noted down as a time stamp 704 associated with each queue entry 702.

In this embodiment, the time of arrival is taken from a time counter 706 that is incremented every clock, and is reset periodically during idle periods when there is no request to the particular FBDIMM channel. A second time counter, Wait Counter 714 is used to produce proper wait time for loads with same timestamp as well as loads with different timestamp. In one embodiment, Wait Counter 714 is loaded with the overall delay required upon reset and is decremented by a fixed amount for every load request that is serviced. Upon moving to service next requests with next higher timestamp, the Wait counter not only is decremented by the fixed amount but also is added with the timestamp. Similar to (706) the Wait counter is reset periodically during idle period when there is no request to the particular FBDIMM channel. When a load request is being serviced, its associated node id as well as the result of the then Wait Counter is recorded.

In one embodiment, if there is a very long period of time during which the switch is continuously active and the Wait Counter is close to zero, error packets are returned for active requests and the counter is forced to the reset value. The process of returning error packets is described in detail below.

Requests are serviced from the queue (702) in some priority order, for instance first in first out and from smaller node id to larger node id, and are sent to the FBDIMM channels. Data returning from the FBDIMM channels is associated with the originating queue entry, and the wait time associated with the queue entry. The data is then moved to a holding buffer (712) with multiple entries for holding returning data packets. A wait counter (714) is associated with each holding entry which is initialized to the wait time determined for the returning packet. The wait counter is decremented every clock cycle and when it reaches zero the packet is returned to the requesting memory controller.

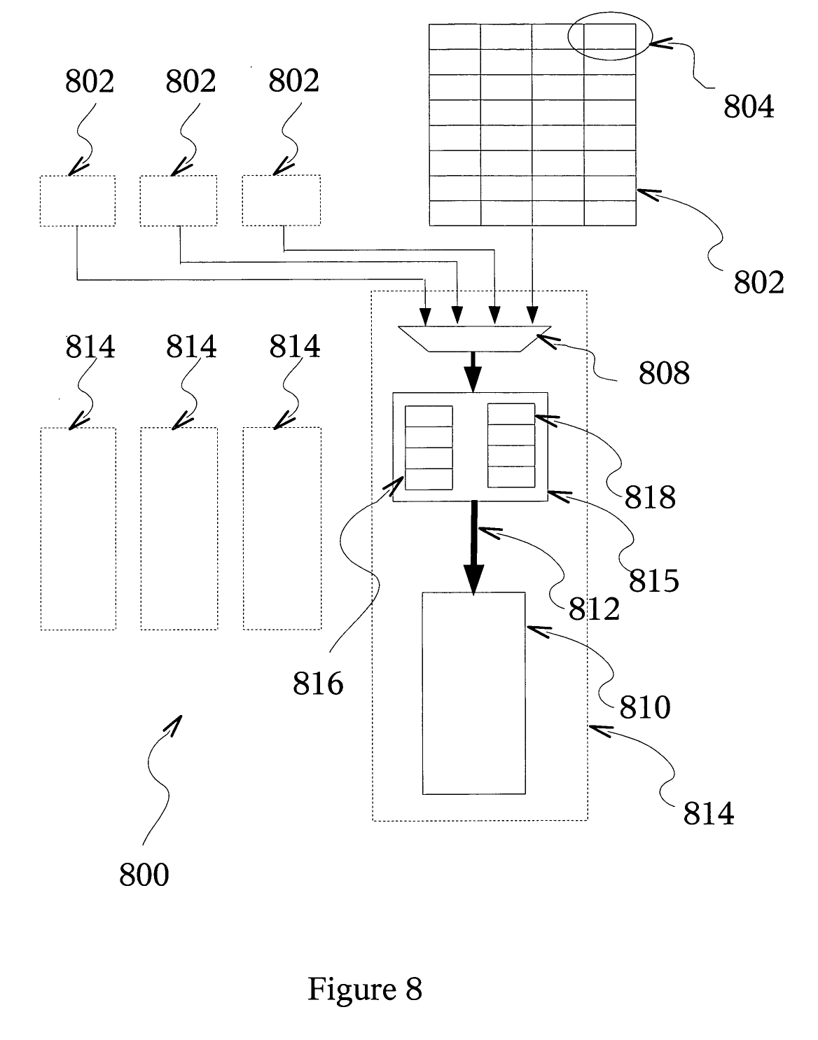

FIG. 8 shows one embodiment of a store handler 800 which can be used in conjunction with switches 110 and 210. In one embodiment, store handler 800 is implemented as a design block within a switch implemented as an integrated circuit.

Recall from the earlier description of FBDIMM elements that a store is performed in two parts: first the data is sent with the id of the targeted memory module 102, and then the store completion command is sent along with the memory address to complete the command. Store controller 800 has a buffer 802 associated with each memory controller 120. Buffer 802 holds data while awaiting the arrival of the store command with the address. The buffer has as many rows as the number of memory modules 102 that the switch can support. It has as many columns as the number of data items that can be buffered on the AMB 104 on the memory modules 102.

In one embodiment, the register 804 at each row column intersection has enough space to hold data for one write command. In some embodiments the data in register 804 is formed by combining more than one data packet from the controller 120.

When a store data packet is received from the memory controller, the store handler uses the target memory module id to index into the corresponding row, and places the data in the next available space for the data in the row. When a store command is received from controller 120, the store handler uses the target memory board id of the command to index into the corresponding row and pick the appropriate data register based on the FBDIMM specification. This may be, for instance, the earliest filled register for the memory board id. The store handler then reads out data from the register 804 and routes the data along with the command to the FBDIMM channel 116 that has the targeted memory module 102 by means of a mux 808.

At the FBDIMM channel 116 the store address and data are placed in a store completion queue 815. In the embodiment shown, completion queue 815 includes a contents addressable memory (CAM) 816 that holds the store address and a set of registers 818 that hold the data. At the point the store address and data enters store completion queue 815, the store is considered to be completed to the memory device 106.

In one embodiment, any subsequent load is cammed against the store address CAM 816, and on a match the data for the latest matching entry is read from the register set 818 and returned directly. As FBDIMM channel slots become available store data is sent out to the targeted memory module 102 on the channel 812, and subsequently store completion commands are sent to complete the store to the memory device.

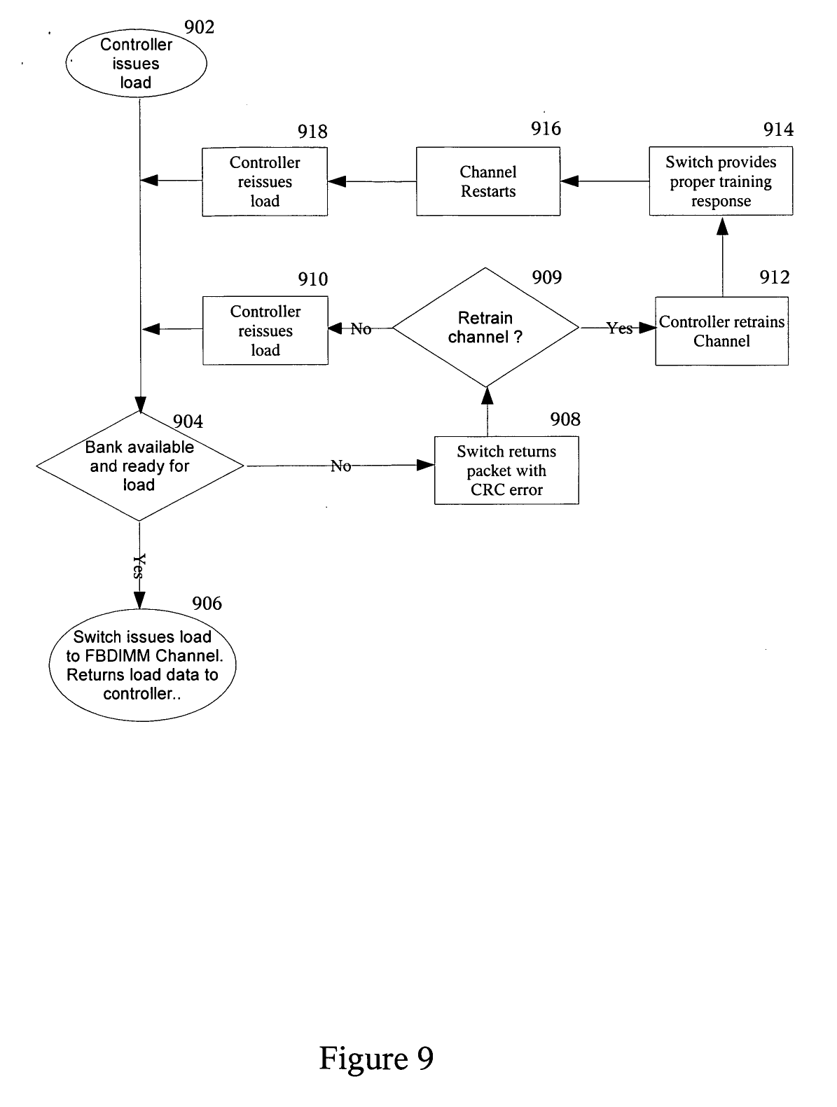

FIG. 9 shows a flow chart of one embodiment of the collision handling function. A collision occurs when, for instance, two loads target the same bank on a memory device 106 with different memory addresses. One bank in the memory device cannot service both loads concurrently. The bank has to service one load first, and when that is done service the second load, with the result that the response for the second load is greatly delayed. This causes a problem with some versions of the FBDIMM protocol specification where load requests are expected to return to the memory controller after a fixed number of cycles following issue of the load request. Other causes for a collision and load delay include: the targeted bank in the memory device is busy completing a write, or the targeted bank in the memory device is in the midst of a refresh operation.

As seen in FIG. 9, a load is issued for the first time by a memory controller at 902. At 904, the switch checks the state of the targeted bank in the targeted memory device for the load. If the targeted bank is available and ready for the load, the load is issued on the FBDIMM channel 116, and data is returned to the requesting controller at the appropriate time at 906.

If the targeted bank is not available or ready for the address of the load it is a collision, and instead of the true data packet, a data packet with a CRC error is returned to the requesting controller at 908. On receiving this error packet, the requesting controller determines if the channel should be retrained at 909 and, if not, reissues the load request at 910 after some delay. If the collision is resolved by the time of the retry, true data is returned to the requesting controller at 906.

If, however, the collision is still present an erroneous data packet is again returned to the requesting controller at 908. This sequence may repeat a few times up to the point where the requesting controller decides at 909 to do a retrain sequence for the channel with the view that the channel is out of synchronization. Control then moves to 912, where the controller 120 retrains the channel 116.

At 914, the switch returns the proper sequence of bits during the retrain sequence, at the end of which the channel is restarted at 916. Now the requesting controller again issues the load at 918.

If the bank is available and ready, true data is returned to the requesting controller at 906. If the collision is still present the entire sequence is repeated. This solution could result in substantial loss in performance of the FBDIMM memory system, and is applicable only when collisions are rare.

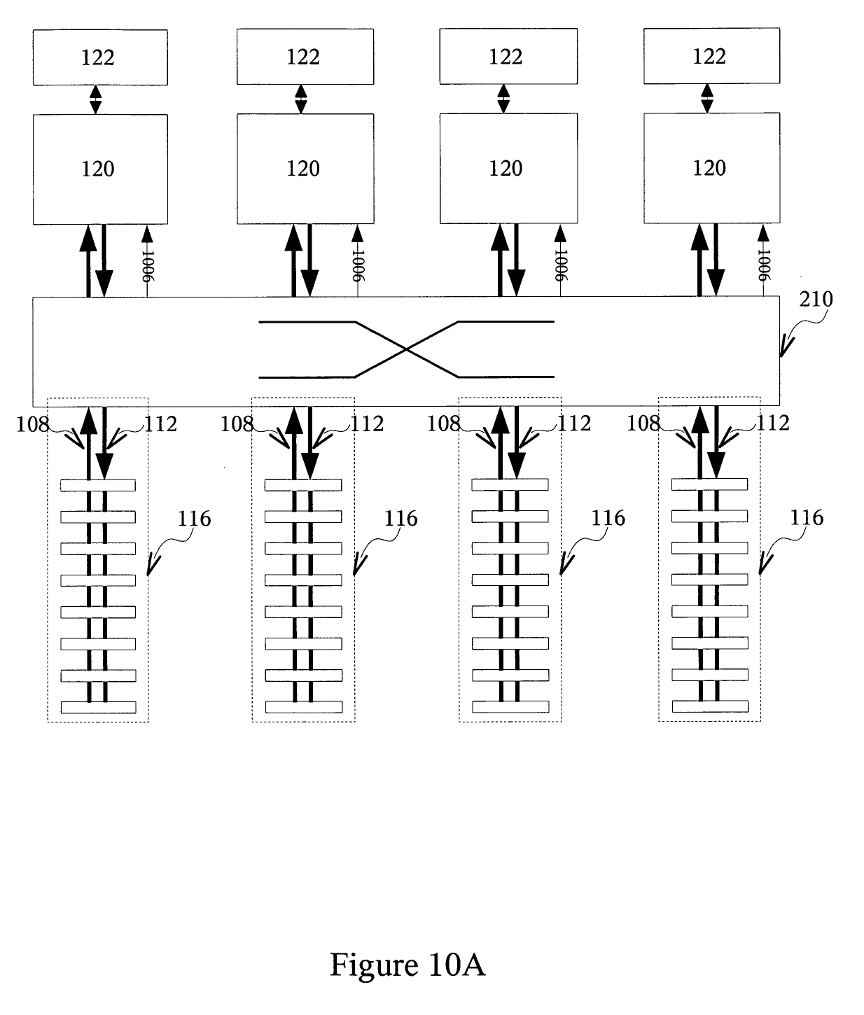

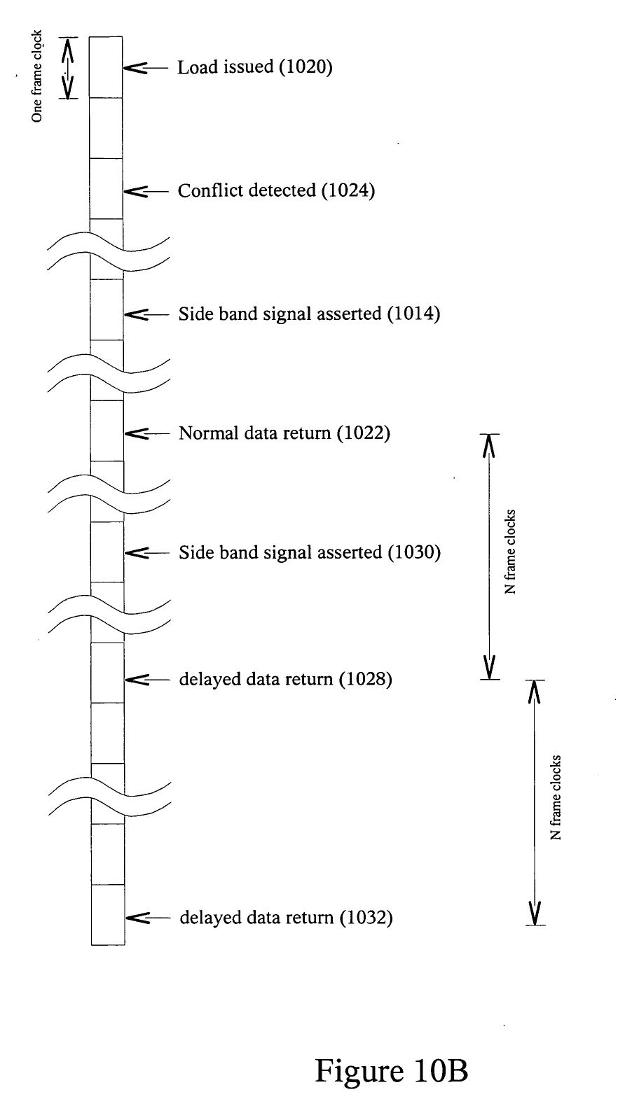

FIG. 10A shows another embodiment of the collision handling function. Here a sideband signal 1006 is added between the memory controller 120 and the switch 210. In normal operation when no collision is detected sideband signal 1006 is kept in an idle state and does not have any impact on the operation of the controller 120.

FIG. 10B shows a timeline diagram depicting the sequence of events that occur during collision handling in a system such as shown in FIG. 10A.

In FIG. 10B, the load is issued at time (1020). The normal time of return of load data back to the controller is (1022). A collision is detected for the load at time (1024). At time (1026), a fixed number of cycles prior to the expected return time of load data to the controller, switch 210 activates sideband signal 1006 for one cycle (1014).

On receiving the active signal the memory controller 120 knows that data return is delayed for some reason, and does not wait for the load data at the original data return cycle, but instead waits for the data at time (1028) some number (N) of cycles after the original data return time (1022), where N is set by a controlling entity at the time the system is powered up. The memory controller keeps time (1028) free so it does not cause self collisions. If data cannot be returned at time (1028), sideband signal 1006 is again activated for one cycle by the switch 210 at time (1030), causing the data return time to be moved up by another N cycles to time (1032). The delaying can be repeated as many times as needed until the data is ready for return.

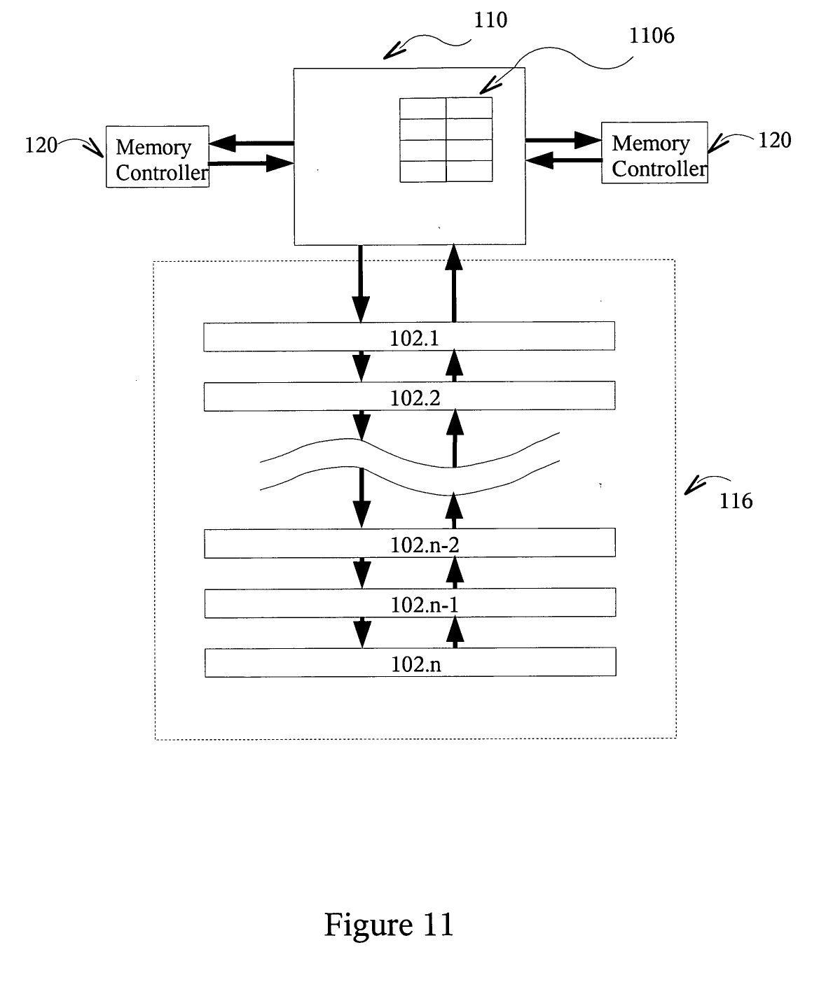

FIG. 11 shows one embodiment of the refresh handling function. Each memory module 102 that is attached to a switch 110 or 210 is assigned a node as its refresh owner. The assignment of owner nodes to memory modules 102 is maintained in a table 1106. The table has a row for every memory module 102 and the owner node number for the memory module 102 is maintained in the table. The table will be updated by a controlling entity such as an operating system at the time when the memory module 102 is first made visible to the system.

When the switch receives a REFRESH command targeting a memory module 102 from the node that is the owner of the memory module 102, the switch directs the REFRESH command to the appropriate FBDIMM channel 116, and thence to the memory module 102 to perform the REFRESH function. In one embodiment, the switch (110 or 210) discards REFRESH commands targeting a memory module 102 from nodes that are not the owner of the memory module 102.

An example of two or more memory controllers sharing one memory channel is illustrated below; assuming the collision handling scheme depicted in FIGS. 10A and 10B is employed.

In a first example, a read command, ReadA, with address A is issued from a first controller (controller 1) to a switch such as switch 110 or 210. The switch functions in chronological order to:
receive ReadA
Decode ReadA command and address
Record that ReadA is from controller 1.
Issue ReadA to memory channel.
Receive data return from memory channel.
Route the return data to controller 1.

In a second example, controller 1 issues a read command, ReadA, with address A, and controller 2 issues a read command, ReadB, with address B. ReadA packet and ReadB packet arrive at the switch at least one packet time apart. Contents of address A and Address B reside in two different DIMM's. The switch functions in chronological order to:
Receive ReadA
Decode ReadA, Receive ReadB
Record that ReadA is from controller 1
Record that ReadB is from controller 2
Issue ReadA to memory channel.
Issue ReadB to memory channel
receive data return for ReadA from memory channel.
receive data return for ReadB from memory channel.
Route the return data for ReadA to controller1
Route the return data for ReadB to controller2.

In a third example, controller 1 issues a read command, ReadA, with address A, and controller 2 issues a read command, ReadB, with address B. ReadA packet and ReadB packet arrive at the switch at the same time. Contents of address A and Address B reside in two different DIMM's. If the data return delay function shown in FIG. 6 is used, the switch functions in chronological order to:
Receive ReadA and ReadB
Decode ReadA and ReadB
Record that ReadA is from controller 1, ReadB is from controller 2
Issue ReadA to memory channel
Issue ReadB to memory channel
receive data return for ReadA from memory channel.
check the ReadA time stamp to determine the proper time to return data to controller 1
receive data return for ReadB from memory channel.
check the ReadB time stamp to determine the proper time to return data to controller 2
Route the return data for ReadA to controller 1

Route the return data for ReadB to controller 2.

In a fourth example, a system with a total of N controllers 120 shares a single memory channel 116. Each controller 120 issues a read command in the same cycle to the switch. If N is greater than the number of buffers that the delay function described in FIG. 6 can handle, the switch functions in chronological order to:
Receive all read commands.
Decode all read commands.
Record each read command and controller association.
Issue Read commands sequentially to the memory channel.
For Read commands that could not fit into the buffer in the switch, a collision handling mechanism such as described in FIG. 9 and FIG. 10 is employed. These Read commands are not issued to the memory channel.
receive data returns from memory channel. check the time stamps to determine proper time to return data to specific controller.
If FIG. 9 scheme is used, wait for each controller to reissue command. If FIG. 10 scheme is used, the switch issues the Read commands to the memory channel, observing the rules of the scheme.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A method for connecting a plurality of memory controllers to one or more memory modules, wherein the memory modules include an advanced memory buffer (AMB) connected to a plurality of memory devices, the method comprising:
providing a switch;
connecting the switch between the plurality of memory controllers and the one or more memory modules; and
routing a memory read request from one of the plurality of memory controllers through the switch to a preselected memory module.

2. A computer system, comprising:
a plurality of processors, wherein each processor issues one or more read requests;
a plurality of memory controllers, wherein each memory controller is associated with one or more processors and wherein each memory controller receives a read request from its associated one or more processors and issues a memory read as a function of the read request;
a memory module, wherein the memory module include an advanced memory buffer (AMB) connected to a plurality of memory devices; and
a switch connected to the AMB and the plurality of memory controllers, wherein the switch transfers memory reads from the memory controllers to the memory module.

3. A memory interface, comprising:
a plurality of input channels, wherein each input channel is configured to receive memory requests from an associated memory controller;
a plurality of output channels, wherein each output channel is configured to return data to its associated memory controller;
memory module means for communicating with one or more memory modules; and
a switch connected to the input channels, the output channels and the memory module means, wherein the switch routes memory requests received from memory controllers to one of the memory modules and routes data from the memory modules to one of the memory controllers.

4. A memory, comprising:
a plurality of input channels, wherein each input channel is configured to receive memory requests from an associated memory controller;
a plurality of output channels, wherein each output channel is configured to return data to its associated memory controller;
one or more memory modules; and
a switch connected to the input channels, the output channels and the one or more memory modules, wherein the switch routes memory requests received from memory controllers to one of the memory modules and routes data from the memory modules to one of the memory controllers.
